(19) United States
(12) Patent Application Publication
(10) Pub. No.: US 2026/0082212 A1
(43) Pub. Date: Mar. 19, 2026

(54) ENERGY-AWARE EXECUTION AND ALLOCATION OF SERVICES IN MOBILE NETWORKS

(71) Applicant: HUAWEI TECHNOLOGIES CO., LTD., Shenzhen (CN)

(72) Inventors: Osama Abboud, Munich (DE); Ramin Khalili, Munich (DE); Artur Hecker, Munich (DE)

(21) Appl. No.: 19/396,489

(22) Filed: Nov. 21, 2025

Related U.S. Application Data
(63) Continuation of application No. PCT/EP2023/063945, filed on May 24, 2023.

(51) Int. Cl. H04W 8/24; H04L 67/60

(52) U.S. Cl. CPC H04W 8/24; H04L 67/60

(57) ABSTRACT

Disclosed is a method of operating a scheduling function for functional components of a mobile network. The method comprises receiving a message, comprising one of: a capability advertisement message of a first execution node of the mobile network, the capability advertisement message comprising default execution capabilities or actual execution capabilities of the first execution node; and a scheduling request message for a functional component of the mobile network, the scheduling request message comprising execution requirements of the functional component. The method further comprises, in response to a received capability advertisement message, re-scheduling one or more functional components running on the first execution node of the mobile network on one or more second execution nodes of the mobile network in accordance with the execution requirements of the respective functional component and a respective execution capability of each execution node of the mobile network.

### CROSS-REFERENCE TO RELATED APPLICATIONS

This application is a continuation of International Application No. PCT/EP2023/063945, filed on May 24, 2023, the disclosure of which is hereby incorporated by reference in its entirety.

### TECHNICAL FIELD

The present disclosure relates to the field of mobile communications, and in particular to various entities and methods in support of energy-aware execution and allocation of services in mobile networks.

### BACKGROUND ART

Future 6G mobile networks are expected to offer a fully virtualized platform for dynamic execution of network functions and application logic based on containerized applications and/or virtual machines (VMs), while taking into account the associated carbon footprint as well.

However, especially the use of carbon-neutral, renewable energy sources (e.g. solar, wind, water, etc.) suffers from fluctuations, undersupply, or even oversupply of energy, so that matching the available resources with the demand is very challenging. This generally leads to the use of less green energy (in case of undersupply) or a waste of excess energy (in case of oversupply).

### SUMMARY

It is an object to overcome the above-mentioned and other drawbacks.

The foregoing and other objects are achieved by the features of the independent claims. Further implementation forms are apparent from the dependent claims, the description and the figures.

According to a first aspect of the present disclosure, a method of operating a scheduling function for functional components of a mobile network is provided. The method comprises receiving a message, comprising one of: a capability advertisement message of a first execution node of the mobile network, the capability advertisement message comprising default execution capabilities or actual execution capabilities of the first execution node; and a scheduling request message for a functional component of the mobile network, the scheduling request message comprising execution requirements of the functional component. The method further comprises, in response to a received capability advertisement message, re-scheduling one or more functional components running on the first execution node of the mobile network on one or more second execution nodes of the mobile network in accordance with the execution requirements of the respective functional component and a respective execution capability of each execution node of the mobile network. The method further comprises, in response to a received scheduling request message, scheduling the functional component on one or more second execution nodes of the mobile network in accordance with the execution requirements of the functional component and a respective execution capability of each execution node of the mobile network.

This realizes energy-aware and zero-carbon resource scheduling in next generation networks, enabled by matching execution capabilities (including energy source characteristics) of the execution nodes and execution requirements of the functional component to be instantiated. The scheduling function is thus able to deploy the functional component on the best location that satisfies the execution requirements and realizes zero-carbon resource scheduling.

The proposed solution may be used in systems where energy sources and/or workloads fluctuate and can have different characteristics (i.e., disparity of energy characteristics depending on location, disparity of workload requirements depending on workload type, deadline, time sensitivity, location sensitivity, etc.). This might be relevant for data centers, wired communications, etc. In particular, the mobile core architecture would be enabled to perform energy aware scheduling and execution on heterogeneously powered platforms and base stations.

A mobile network as used herein may refer to a telecommunications network having radio links between the fixed network infrastructure and the mobile end nodes.

A network function or NF as used herein may refer to a functional element within a virtualized network architecture (e.g., 3GPP 5G/6G system architectures) being characterized by well-defined external interfaces and a well-defined functional behavior.

A functional component as used herein may refer to a network function (see above) or to an application.

A scheduling function as used herein may refer to a specific NF of a control plane of a 3GPP system architecture being adapted for on-demand instantiation of other functional components in accordance with available processing, storage and/or networking resources of the virtualized mobile network.

An execution node as used herein may refer to a structural element of a network architecture being adapted for exposing processing, storage and/or networking resources to the virtualized mobile network.

Default execution capabilities as used herein may refer to execution capabilities being used in the absence of actual execution capabilities.

Actual execution capabilities as used herein may refer to temporary execution capabilities. For example, a computing capacity of an execution node may vary in accordance with a renewable energy supply.

In a possible implementation form, re-scheduling or scheduling may comprise: matching the default execution capabilities of each execution node with the execution requirements; matching the actual execution capabilities of any execution nodes having matching default execution capabilities with the execution requirements; selecting the one or more second execution nodes from any execution nodes having matching actual execution capabilities in accordance with a scheduling policy; balancing an execution load between the one or more second execution nodes; sending, to the one or more second execution nodes, a respective scheduling order for the functional component; and receiving, from the one or more second execution nodes, a respective scheduling confirmation for the functional component.

A scheduling policy as used herein may refer to a definite course of action selected from among alternatives and in light of given conditions to guide and determine present and future (scheduling) decisions.

Balancing as used herein may refer to an attempt of even distribution of a plurality of operations.

In a possible implementation form, re-scheduling or scheduling may further comprise: resetting a countdown timer; and in response to a lapse of the countdown timer, proceeding with the selecting step.

According to a third aspect of the present disclosure, a method of operating an agent function for an execution node of a mobile network is provided. The method comprises sending, to a scheduling function of the mobile network, one or more capability advertisement messages of the execution node. The respective capability advertisement message comprises one of: default execution capabilities of the execution node, and actual execution capabilities of the execution node. The method further comprises receiving, from the scheduling function, a scheduling order for a functional component of the mobile network. The method further comprises launching the functional component on the execution node. The method further comprises sending, to the scheduling function, a scheduling confirmation for the functional component.

An agent function as used herein may refer to a specific NF of a control plane of a 3GPP system architecture being adapted to act for another entity not forming part of the control plane, such as an execution node, for example.

In a possible implementation form, the method may further comprise receiving, from the execution node, one or more of: the default execution capabilities of the execution node, and the actual execution capabilities of the execution node.

According to a fifth aspect of the present disclosure, a method of operating a functional component of a mobile network. The method may comprise sending, to a scheduling function of the mobile network, a scheduling request message for the functional component of the mobile network, the scheduling request message comprising execution requirements of the functional component.

In a possible implementation form, the default execution capabilities may comprise: an identifier of the execution node, a status of the execution node, a default computing capacity of the execution node, a default energy capacity of the execution node, a default energy capacity prediction of the execution node, default carbon emissions per gigabyte, GB, of communication, default carbon emissions per gigabyte, GB, of storage, and default carbon emissions per floating point operations per second, FLOPS, of computing.

In a possible implementation form, the actual execution capabilities may comprise: an identifier of the execution node, a status of the execution node, an actual computing capacity of the execution node, an actual energy capacity of the execution node, a percentage of the actual energy capacity relating to renewable energy supply and exceeding a general energy demand at the execution node; an actual energy capacity prediction of the execution node, actual carbon emissions per gigabyte, GB, of communication, actual carbon emissions per gigabyte, GB, of storage, actual carbon emissions per floating point operations per second, FLOPS, of computing, an identifier of an event underlying the capability advertisement message, and a validity period of the actual execution capabilities.

In a possible implementation form, the event may comprise a periodic event.

In a possible implementation form, the scheduling policy may comprise one of: a closest match of the execution requirements and their applicable execution capabilities, a closest geographic proximity relative to users of the functional component, a lowest latency relative to the users of the functional component, a best performance associated with the execution of the functional component (in case of multiple options having same energy characteristics, chose the location with best performance), a least energy cost associated with an execution of the functional component (in case of multiple options having same energy characteristics, chose the location with least energy cost), and a least carbon emission associated with the execution of the functional component.

In a possible implementation form, the execution requirements may comprise: an identifier of the functional component, a job type of the functional component, a job quality of service, QoS, of the functional component, a preferred location, a preferred energy source, processing requirements of the functional component, maximum carbon emissions per gigabyte, GB, of communication, maximum carbon emissions per gigabyte, GB, of storage, and maximum carbon emissions per floating point operations per second, FLOPS, of computing.

In a possible implementation form, the job type of the functional component may comprise one of: core network function, NF, application, and machine learning workload.

In a possible implementation form, the job QoS of the functional component may comprise one of: a 3GPP QoS level, an application QoS level, and a machine learning workload QoS level.

A 3GPP QoS level as used herein may refer to a particular combination of throughput, delay and/or packet loss ratio represented by a QoS Flow Identifier, QFI.

An application QoS level as used herein may refer to a particular combination of throughput, delay and/or packet loss ratio.

A machine learning workload QoS level as used herein may refer to a particular combination of throughput and/or packet loss ratio (due to being non delay-sensitive).

In a possible implementation form, the functional component may comprise one of: a network function, NF, and an application.

According to a seventh aspect of the present disclosure, a computer program is provided, comprising a program code for performing the method of the first aspect or the method of the third aspect or the method of the fifth aspect, when executed on a computer.

According to a second aspect of the present disclosure, a scheduling function for functional components of a mobile network is provided. The scheduling function is configured for executing the method of the first aspect of operating a scheduling function for functional components of a mobile network.

According to a fourth aspect of the present disclosure, an agent function for an execution node of a mobile network is provided. The agent function is configured for executing the method of the third aspect of operating an agent function for an execution node of a mobile network.

According to a sixth aspect of the present disclosure, a functional component of a mobile network is provided. The functional component is configured for executing the method of the fifth aspect of operating a functional component of a mobile network.

According to an eighth aspect of the present disclosure, a mobile network is provided, comprising a network repository function, NRF, an execution node, and a functional component of the sixth aspect of the mobile network. The NRF comprises a scheduling function of the second aspect for functional components of the mobile network. The execution node comprises a user plane function, UPF. The UPF in turn comprises an agent function of the fourth aspect for the execution node of the mobile network.

A “network repository function” or NRF as used herein may refer to a specific NF of a control plane of a 3GPP system architecture being adapted for discovery of available NFs and their supported services.

A “user plane function” or UPF as used herein may refer to a NF of a data/user plane of a 3GPP system architecture being adapted for processing (e.g. packet forwarding, policy enforcement) of user data in between the radio access network and the data network.

According to a ninth aspect of the present disclosure, an edge data network for a mobile network is provided. The edge data network comprises an edge application server, EAS, an execution node, and a functional component of the sixth aspect. The EAS comprises a scheduling function of the second aspect for functional components of the mobile network. The execution node comprises an edge enabler server, EES. The EES in turn comprises an agent function of the fourth aspect for the execution node of the mobile network.

An edge (data) network or EDN as used herein may refer to an architectural modification of the 3GPP system architecture in accordance with ETSI Technical Specification 123 558 V17.3.0 (see section 6.2) and being adapted for computation and data storage as close to the point of request (i.e., user) as possible in order to deliver low latency and save bandwidth.

An edge application server, EAS as used herein may refer to an application server in accordance with ETSI Technical Specification 123 558 V17.3.0 (see section 6.3.6). Client applications resident in the UE connect to the EAS in order to avail the provided services with the benefits of edge computing.

An edge enabler server, EES as used herein may refer to a server providing supporting functions in accordance with ETSI Technical Specification 123 558 V17.3.0 (see section 6.3.2).

According to a tenth aspect of the present disclosure, a machine learning system is provided, comprising a scheduling function of the second aspect for functional components of the mobile network, one or more execution nodes having renewable energy supply, and one or more instances of a functional component of the sixth aspect of the mobile network. The respective execution node comprises an agent function of the fourth aspect for the respective execution node of the mobile network. The respective instance of the functional component comprises an artificial neural network, ANN, being configured for split learning in accordance with a machine learning workload.

An renewable energy supply as used herein may refer to energy supply from renewable sources such as wind power, water power and solar power.

Machine learning as used herein may refer to a class of methods for turning sample data (i.e., input data in combination with desired output data) into statistical models being adapted to make predictions even on unseen samples.

An artificial neural network, ANN as used herein may refer to a particular machine learning method based on forward propagation of input data through the ANN and subsequent back propagation of an error of the resulting output data vs. the desired output data.

Split learning as used herein may refer to a particular machine learning method wherein a deep neural network (i.e., having a plurality of neuron layers) is split into multiple sections, each of which may be located and trained on a different entity/device.

In a possible implementation form, the renewable energy supply may exceed a general energy demand at the respective execution node.

### BRIEF DESCRIPTION OF DRAWINGS

The above-described aspects and implementations will now be explained with reference to the accompanying drawings, in which the same or similar reference numerals designate the same or similar elements.

The drawings are to be regarded as being schematic representations, and elements illustrated in the drawings are not necessarily shown to scale. Rather, the various elements are represented such that their function and general purpose become apparent to those skilled in the art.

FIG. 1 illustrates a method in accordance with the present disclosure of operating a scheduling function for functional components of a mobile network;

FIG. 2 illustrates an interplay between a more detailed implementation of the method of FIG. 1 and a method in accordance with the present disclosure of operating an agent function for an execution node of a mobile network;

FIG. 3 illustrates an interplay between a more detailed implementation of the method of FIG. 1 and a method in accordance with the present disclosure of operating a functional component of a mobile network;

FIG. 4 illustrates a mobile network in accordance with the present disclosure;

FIG. 5 illustrates an edge data network in accordance with the present disclosure for a mobile network; and

FIG. 6 illustrates a machine learning system in accordance with the present disclosure.

### DETAILED DESCRIPTIONS OF DRAWINGS

In the following description, reference is made to the accompanying drawings, which form part of the disclosure, and which show, by way of illustration, specific aspects of implementations of the present disclosure or specific aspects in which implementations of the present disclosure may be used. It is understood that implementations of the present disclosure may be used in other aspects and comprise structural or logical changes not depicted in the figures. The following detailed description, therefore, is not to be taken in a limiting sense, and the scope of the present disclosure is defined by the appended claims.

For instance, it is understood that a disclosure in connection with a described method may also hold true for a corresponding apparatus or system configured to perform the method and vice versa. For example, if one or a plurality of specific method steps are described, a corresponding device may include one or a plurality of units, e.g. functional units, to perform the described one or plurality of method steps (e.g. one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g. functional units, a corresponding method may include one step to perform the functionality of the one or plurality of units (e.g. one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary implementations and/or aspects described herein may be combined with each other, unless specifically noted otherwise.

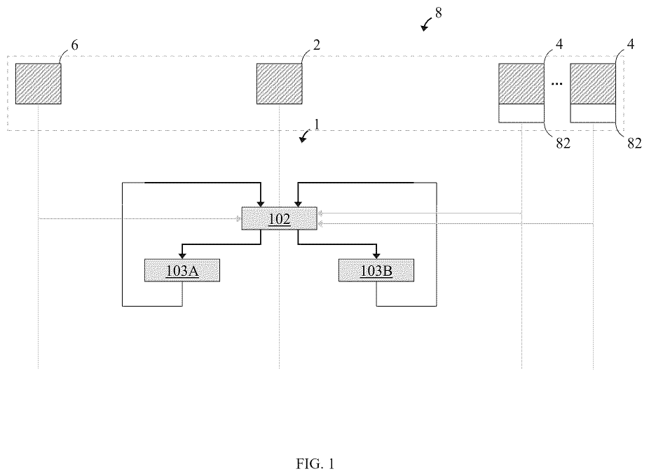

FIG. 1 illustrates a method 1 in accordance with the present disclosure of operating a scheduling function 2 for functional components 6 of a mobile network 8.

The mobile network 8 is indicated by a dashed rectangle enclosing the relevant functional elements, namely the scheduling function 2 enclosed by a functional component 6 to the left and multiple agent functions 4 for respective execution nodes 82 to the right.

The method 1 comprises a step of receiving 102 a message. The message comprises either a capability advertisement message of a first execution node 82 of the mobile network 8 (and arriving from one of the agent functions 4 to the right) or a scheduling request message for a functional component 6 of the mobile network 8 (and arriving from the functional component 6 to the left).

A capability advertisement message, if any, comprises default execution capabilities or actual execution capabilities of the advertising first execution node 82.

A scheduling request message, if any, comprises execution requirements of the functional component 6.

In response to a received capability advertisement message, the method 1 further comprises a step of re-scheduling 103A one or more functional components 6 running on the first execution node 82 of the mobile network 8 on one or more second execution nodes 82 of the mobile network 8 in accordance with the execution requirements of the respective functional component 6 and a respective execution capability of each execution node 82 of the mobile network 8.

Note that the one or more second execution nodes 82 may include the first execution node 82. In other words, receiving a capability advertisement message does not necessarily imply an actual re-scheduling of the one or more functional components 6 running on the advertising first execution node 82.

In response to a received scheduling request message, the method 1 further comprises a step of scheduling 103B the functional component 6 on one or more second execution nodes 82 of the mobile network 8 in accordance with the execution requirements of the functional component 6 and a respective execution capability of each execution node 82 of the mobile network 8.

In summary, a scheduling request by a functional component 6 triggers a scheduling 103B of an instance of said functional component 6, whereas a capability advertisement by an agent function 4 triggers a re-scheduling 103A of instances of functional components 6 running on the execution node 82 being represented by the agent function 4.

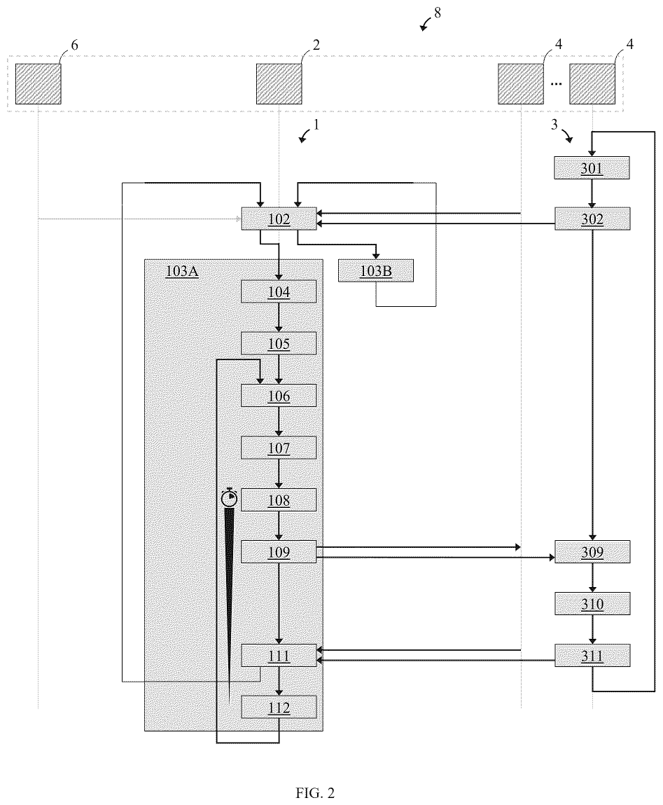

FIG. 2 illustrates an interplay between a more detailed implementation of the method 1 of FIG. 1 and a method 3 in accordance with the present disclosure of operating an agent function 4 for an execution node 82 of a mobile network 8.

On the side of the agent function 4 and its execution node 82, the method 3 may comprise a step of receiving 301, from the execution node 82, one or more of: default execution capabilities of the execution node 82, and actual execution capabilities of the execution node 82.

The default execution capabilities may comprise: a unique identifier of the execution node 82, a status of the execution node 82 (such as on-line, off-line, etc.), a default computing capacity of the execution node 82 (in floating point operations per second, FLOPS), a default energy capacity of the execution node 82 (for the current advertising period, in kW), a default energy capacity prediction of the execution node 82 (for the next advertising period, in kW), default carbon emissions per gigabyte, GB, of communication (in kg/GB), default carbon emissions per gigabyte, GB, of storage (in kg/GB), and default carbon emissions per FLOPS of computing (in kg/GFLOPS).

The actual execution capabilities may comprise: the unique identifier of the execution node 82, the status of the execution node 82, an actual computing capacity of the execution node 82 (in FLOPS), an actual energy capacity of the execution node 82 (in kW), a percentage of the actual energy capacity relating to renewable energy supply and exceeding a general energy demand at the execution node 82 (i.e., excess energy in %); an actual energy capacity prediction of the execution node 82 (in kW), actual carbon emissions per gigabyte, GB, of communication (in kg/GB), actual carbon emissions per gigabyte, GB, of storage (in kg/GB), actual carbon emissions per FLOPS of computing (in kg/GFLOPS), an identifier of an event underlying the capability advertisement message, and a validity period of the actual execution capabilities (i.e., the current advertising period).

For example, the event giving rise to the capability advertisement message may comprise a periodic event, and the identifier of said event may indicate so.

The method 3 further comprises a step of sending 302, to a scheduling function 2 of the mobile network 8, one or more capability advertisement messages of the execution node 82.

The respective capability advertisement message comprises one of the default execution capabilities of the execution node 82, and the actual execution capabilities of the execution node 82.

Note that the execution capabilities may be the ones just received or most recent ones being re-sent periodically, for example.

As previously mentioned in connection with FIG. 1, a capability advertisement by an agent function 4 triggers a re-scheduling 103A of instances of functional components 6 running on the execution node 82 being represented by the agent function 4.

Thus, on the side of the scheduling function 2, the step of re-scheduling 103A may comprise a step of matching 104 the default execution capabilities of each execution node 82 with the execution requirements. This accomplishes a coarse filtering of the execution nodes 82 of the mobile network 8.

The step of re-scheduling 103A may further comprise a step of matching 105 the actual execution capabilities of any execution nodes 82 having matching default execution capabilities with the execution requirements. This carries out a fine filtering of the execution nodes 82 of the mobile network 8 still being relevant.

The step of re-scheduling 103A may further comprise a step of selecting 106 the one or more second execution nodes 82 from any execution nodes 82 having matching actual execution capabilities, in accordance with a scheduling policy.

In particular, the scheduling policy may comprise one of: a closest match of the execution requirements and their applicable execution capabilities (possibly in accordance with a predefined metric), a closest geographic proximity relative to users of the functional component 6, a lowest latency relative to the users of the functional component 6, a best performance associated with the execution of the functional component 6, a least energy cost associated with an execution of the functional component 6, and a least carbon emission associated with the execution of the functional component 6.

The step of re-scheduling 103A may further comprise a step of balancing 107 an execution load between the one or more second execution nodes 82. Note that in case of a single second execution node 82 the balancing step is not meaningful and skipped.

The step of re-scheduling 103A may further comprise a step of resetting 108 a countdown timer to a lapse after a particular period, for optional periodic assessment of optimization opportunities.

The step of re-scheduling 103A may further comprise a step of sending 109, to the one or more second execution nodes 82, a respective scheduling order for the functional component 6.

On the side of the agent function 4 and its execution node 82, the method 3 further comprises a step of receiving 309, from the scheduling function 2, the scheduling order for the functional component 6.

The method 3 further comprises a step of launching 310 the functional component 6 on the execution node 82.

The method 3 further comprises a step of sending 311, to the scheduling function 2, a scheduling confirmation for the functional component 6.

On the side of the scheduling function 2, the step of re-scheduling 103A may further comprise a step of receiving 111, from the one or more second execution nodes 82, the respective scheduling confirmation for the functional component 6.

In response to the scheduling confirmation, the method 1 proceeds with the receiving 102 step.

However, the step of re-scheduling 103A may further comprise a step of proceeding 112 with the selecting 106 step, in response to a lapse of the countdown timer armed in step 108.

Note that the proceeding 112 step may also be incorporated into the receiving 102 step, so that the receiving 102 step serves as a ‘callback state’.

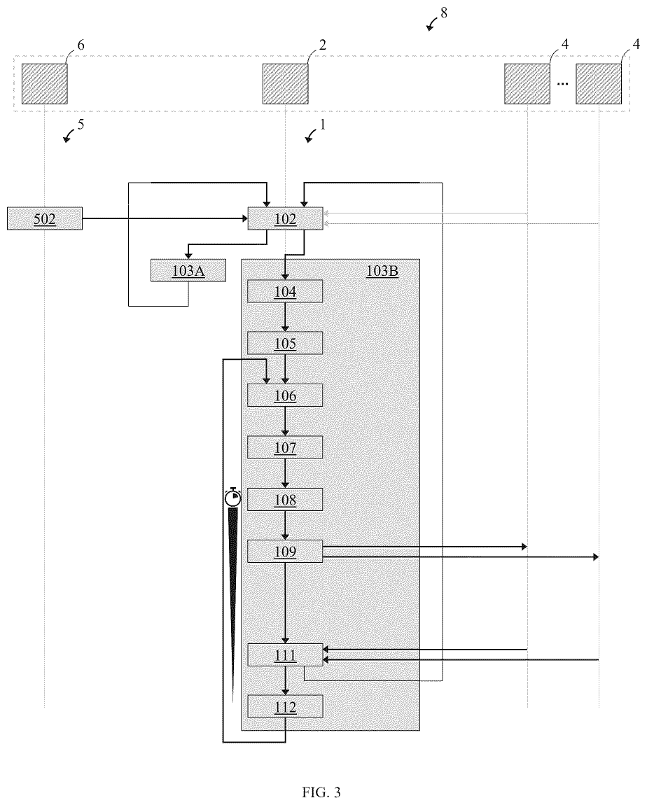

FIG. 3 illustrates an interplay between a more detailed implementation of the method 1 of FIG. 1 and a method 5 in accordance with the present disclosure of operating a functional component 6 of a mobile network 8.

The functional component 6 may comprise one of: a network function, NF, and an application.

On the side of the functional component 6, the method 5 comprises sending 502, to a scheduling function 2 of the mobile network 8, a scheduling request message for the functional component 6 of the mobile network 8.

The scheduling request message comprises execution requirements of the functional component 6.

The execution requirements may comprise: a unique identifier of the functional component 6, a job type of the functional component 6, a job quality of service, QoS, of the functional component 6, a preferred location, a preferred energy source (such as wind power, water power and solar power), processing requirements of the functional component 6, maximum carbon emissions per gigabyte, GB, of communication (in kg/GB), maximum carbon emissions per gigabyte, GB, of storage (in kg/GB), and maximum carbon emissions per floating point operations per second, FLOPS, of computing (in kg/GFLOPS).

The job type of the functional component 6 may comprise one of: core network function, application, and machine learning workload.

The job QoS of the functional component 6 may comprise one of: a 3GPP QoS level, an application QoS level, and a machine learning workload QoS level (i.e., non-delay-sensitive).

As previously mentioned in connection with FIG. 1, a scheduling request by a functional component 6 triggers a scheduling 103B of an instance of said functional component 6.

Note that the scheduling 103A step and the re-scheduling 103A step respectively attempt to map functional components 6 and their execution requirements to execution nodes 82 and their execution capabilities.

It is thus not surprising that on the side of the scheduling function 2, the step of scheduling 103B may comprise the steps 104-112 already explained in more detail in connection with FIG. 2.

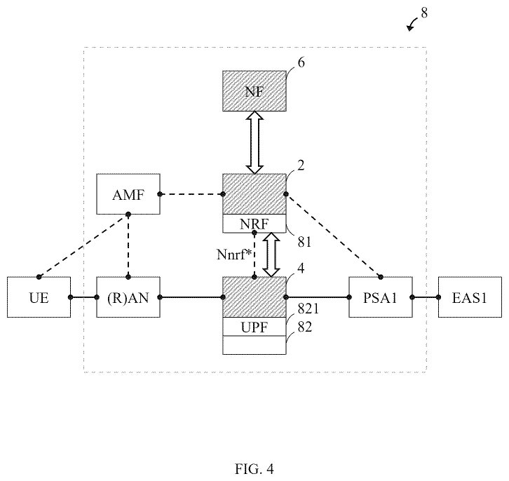

FIG. 4 illustrates a mobile network 8 in accordance with the present disclosure.

In accordance with the depicted 3GPP implementation, the functional component 6, the scheduling function 2 and the agent function 4 may respectively be executed in the core network of the mobile network 8.

To this end, the functional component 6 to be instantiated may be included in the mobile network 8, the scheduling function 2 may be comprised by a network repository function, NRF 81, of the mobile network 8, and the agent function 4 may be comprised by a user plane function, UPF 821, of the mobile network 8. The UPF 821 on its part may be comprised by the execution node 82 represented by the agent function 4. An instance of the functional component 6 may thus be hosted by the UPF 821 which is in turn hosted by the exemplary execution node 82.

Note that the UPF-NRF interface identified as Nnrf* is subject to extensions in accordance with the default and actual execution capabilities of the execution node 82. In particular, this may involve modifications to the 3GPP Technical Specification 29.510 (see sections 5.2.2.2 NFRegister and 5.2.2.3 NFUpdate).

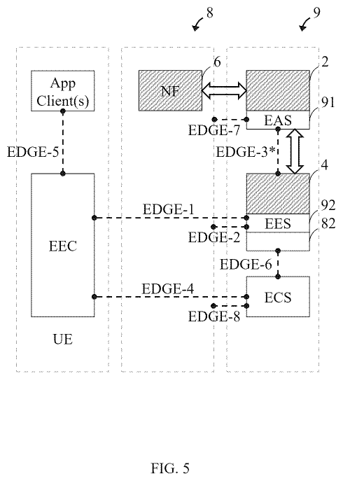

FIG. 5 illustrates an edge data network 9 in accordance with the present disclosure for a mobile network 8.

In accordance with the depicted implementation, the functional component 6 may be executed in the core network of the mobile network 8, whereas the scheduling function 2 and the agent function 4 may respectively be executed in the edge data network 9 of the mobile network 8.

To this end, the functional component 6 to be instantiated may be included in the mobile network 8, the scheduling function 2 may be comprised by an edge application server, EAS 91, of an edge data network 9 for the mobile network 8, and the agent function 4 may be comprised by an edge enabler server, EES 92, of the edge data network 9. The EES 92 on its part may be comprised by the execution node 82 represented by the agent function 4. An instance of the functional component 6 may thus be hosted by the EES 92 which is in turn hosted by the exemplary execution node 82.

Of note, the EAS-EES interface identified as EDGE-3* is subject to extensions in accordance with the default and actual execution capabilities of the execution node 82. In particular, this may involve modifications to the 3GPP Technical Specification 23.558 (see sections 8.4.3.4.2/Eees_EASRegistration_Request and 8.4.3.4.3/Eees_EASRegistration_Update).

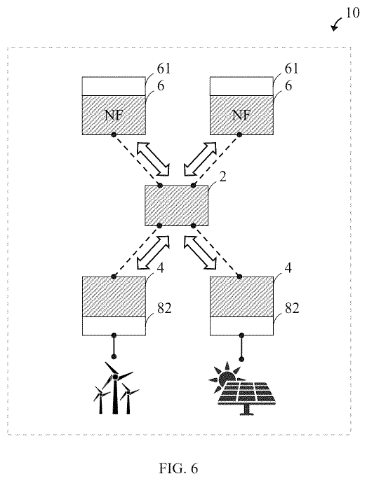

FIG. 6 illustrates a machine learning system 10 in accordance with the present disclosure.

Machine learning requires lots of energy for training. Sustainability is important by allowing specific assignment of machine learning workloads to data centers with access to renewable energy.

The machine learning system 10 thus comprises one or more execution nodes 82 having renewable energy supply and being represented by respective agent functions 4.

The renewable energy supply may exceed a general energy demand at the respective execution node 82. Especially such time periods of excessive renewable (and carbon-neutral) energy supply may be exploited for machine learning purposes.

In accordance with the depicted implementation, one or more instances of a functional component 6 may be instantiated.

The respective instance comprises an artificial neural network, ANN 61.

For example, a functional component 6 including a deep neural network may be subdivided into multiple sections/instances which may be trained in accordance with a split learning method, and later on used for split inference.

The machine learning system 10 further comprises a scheduling function 2 for functional components 6.

As mentioned previously, a scheduling request by a functional component 6 triggers a scheduling 103B of the one or more instances of the functional component 6 at the one or more execution nodes 82. In case of multiple sections/instances, respective scheduling requests may apply.

The one or more instances of the functional component 6 may undergo a (split) learning procedure in accordance with the machine learning workload, using the excessive renewable energy supply.

The resulting trained ANN(s) 61 may later on be used for a (split) inference procedure.

The present disclosure has been described in conjunction with various implementations as examples. However, other variations can be understood and effected by those persons skilled in the art and practicing the claimed matter, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation. A computer program may be stored/distributed on a suitable medium, such as an optical storage medium or a solid-state medium supplied together with or as part of other hardware, but may also be distributed in other forms, such as via the Internet or other wired or wireless telecommunication systems.

1. A method (1) of operating a scheduling function (2) for functional components (6) of a mobile network (8), the method (1) comprising
receiving (102) a message, comprising one of:
capability advertisement message of a first execution node (82) of the mobile network (8), the capability advertisement message comprising default execution capabilities or actual execution capabilities of the first execution node (82); and
a scheduling request message for a functional component (6) of the mobile network (8), the scheduling request message comprising execution requirements of the functional component (6);
in response to a received capability advertisement message, re-scheduling (103A) one or more functional components (6) running on the first execution node (82) of the mobile network (8) on one or more second execution nodes (82) of the mobile network (8) in accordance with the execution requirements of the respective functional component (6) and a respective execution capability of each execution node (82) of the mobile network (8); and
in response to a received scheduling request message, scheduling (103B) the functional component (6) on one or more second execution nodes (82) of the mobile network (8) in accordance with the execution requirements of the functional component (6) and a respective execution capability of each execution node (82) of the mobile network (8).

2. The method (1) of claim 1,
wherein re-scheduling (103A) one or more functional components (6) running on the first execution node (82) of the mobile network (8) on one or more second execution nodes (82) of the mobile network (8) or scheduling (103B) the functional component (6) on one or more second execution nodes (82) of the mobile network (8) comprises:
matching (104) the default execution capabilities of each execution node (82) with the execution requirements;
matching (105) the actual execution capabilities of any execution nodes (82) having matching default execution capabilities with the execution requirements;
selecting (106) the one or more second execution nodes (82) from any execution nodes (82) having matching actual execution capabilities in accordance with a scheduling policy;
balancing (107) an execution load between the one or more second execution nodes (82);
sending (109), to the one or more second execution nodes (82), a respective scheduling order for the functional component (6); and
receiving (111), from the one or more second execution nodes (82), a respective scheduling confirmation for the functional component (6).

3. The method (1) of claim 2,
wherein re-scheduling (103A) one or more functional components (6) running on the first execution node (82) of the mobile network (8) on one or more second execution nodes (82) of the mobile network (8) or scheduling (103B) the functional component (6) on one or more second execution nodes (82) of the mobile network (8) further comprises:
resetting (108) a countdown timer; and
in response to a lapse of the countdown timer, proceeding (112) with the selecting (106) step.

4. The method (1) of claim 2,
wherein the default execution capabilities comprise:
an identifier of the execution node (82),
a status of the execution node (82),
a default computing capacity of the execution node (82),
a default energy capacity of the execution node (82),
a default energy capacity prediction of the execution node (82),
default carbon emissions per gigabyte, GB, of communication,
default carbon emissions per gigabyte, GB, of storage, and
default carbon emissions per floating point operations per second, FLOPS, of computing.

5. The method (1) of claim 2,
wherein the actual execution capabilities comprise:
an identifier of the execution node (82),
a status of the execution node (82),
an actual computing capacity of the execution node (82),
an actual energy capacity of the execution node (82),
a percentage of the actual energy capacity relating to renewable energy supply and exceeding a general energy demand at the execution node (82);
an actual energy capacity prediction of the execution node (82),
actual carbon emissions per gigabyte, GB, of communication,
actual carbon emissions per gigabyte, GB, of storage,
actual carbon emissions per floating point operations per second, FLOPS, of computing,
an identifier of an event underlying the capability advertisement message, and
a validity period of the actual execution capabilities.

6. The method (1) of claim 2,
wherein the event comprises a periodic event.

7. The method (1) of claim 2,
wherein the scheduling policy comprise one of:
a closest match of the execution requirements and their applicable execution capabilities,
a closest geographic proximity relative to users of the functional component (6),
a lowest latency relative to the users of the functional component (6),
a best performance associated with the execution of the functional component (6),
a least energy cost associated with an execution of the functional component (6), and
a least carbon emission associated with the execution of the functional component (6).

8. The method (1) of claim 2,
wherein the execution requirements comprise:
an identifier of the functional component (6),
a job type of the functional component (6),
a job quality of service, QoS, of the functional component (6),
a preferred location,
a preferred energy source,
processing requirements of the functional component (6),
maximum carbon emissions per gigabyte, GB, of communication,
maximum carbon emissions per gigabyte, GB, of storage, and
maximum carbon emissions per floating point operations per second, FLOPS, of computing.

9. The method (1) of claim 2,
wherein the job type of the functional component (6) comprises one of:
core network function, NF,
application, and
machine learning workload.

10. The method (1) of claim 2,
wherein the job QoS of the functional component (6) comprises one of:
a 3GPP QoS level,
an application QoS level, and
a machine learning workload QoS level.

11. The method (1) of claim 2,
wherein the functional component (6) comprises one of:
a network function, NF, and
an application.

12. A method (3) of operating an agent function (4) for an execution node (82) of a mobile network (8), the method (3) comprising
sending (302), to a scheduling function (2) of the mobile network (8), one or more capability advertisement messages of the execution node (82), the respective capability advertisement message comprising one of:
default execution capabilities of the execution node (82), and
actual execution capabilities of the execution node (82);
receiving (309), from the scheduling function (2), a scheduling order for a functional component (6) of the mobile network (8);
launching (310) the functional component (6) on the execution node (82); and
sending (311), to the scheduling function (2), a scheduling confirmation for the functional component (6).

13. The method (3) of claim 12, further comprising
receiving (301), from the execution node (82), one or more of:
the default execution capabilities of the execution node (82), and
the actual execution capabilities of the execution node (82).

14. A communication apparatus, comprising: a transceiver; at least one processor; and one or more memories coupled to the at least one processor and storing programming instructions for execution by the at least one processor to cause the communication apparatus to:
receive (102) a message, comprising one of:
a capability advertisement message of a first execution node (82) of the mobile network (8), the capability advertisement message comprising default execution capabilities or actual execution capabilities of the first execution node (82); and
a scheduling request message for a functional component (6) of the mobile network (8), the scheduling request message comprising execution requirements of the functional component (6);
in response to a received capability advertisement message, re-schedule (103A) one or more functional components (6) running on the first execution node (82) of the mobile network (8) on one or more second execution nodes (82) of the mobile network (8) in accordance with the execution requirements of the respective functional component (6) and a respective execution capability of each execution node (82) of the mobile network (8); and
in response to a received scheduling request message, schedule (103B) the functional component (6) on one or more second execution nodes (82) of the mobile network (8) in accordance with the execution requirements of the functional component (6) and a respective execution capability of each execution node (82) of the mobile network (8).

15. The communication apparatus of claim 14, wherein the programming instructions, when executed by the at least one processor, cause the communication apparatus to:
match (104) the default execution capabilities of each execution node (82) with the execution requirements;
match (105) the actual execution capabilities of any execution nodes (82) having matching default execution capabilities with the execution requirements;
select (106) the one or more second execution nodes (82) from any execution nodes (82) having matching actual execution capabilities in accordance with a scheduling policy;
balance (107) an execution load between the one or more second execution nodes (82);
send (109), to the one or more second execution nodes (82), a respective scheduling order for the functional component (6); and
receive (111), from the one or more second execution nodes (82), a respective scheduling confirmation for the functional component (6).

16. The communication apparatus of claim 15, wherein the programming instructions, when executed by the at least one processor, cause the communication apparatus to:
reset (108) a countdown timer; and
in response to a lapse of the countdown timer, proceed (112) with the selecting (106) step.

17. The communication apparatus of claim 15,
wherein the default execution capabilities comprise:
an identifier of the execution node (82),
a status of the execution node (82),
a default computing capacity of the execution node (82),
a default energy capacity of the execution node (82),
a default energy capacity prediction of the execution node (82),
default carbon emissions per gigabyte, GB, of communication,
default carbon emissions per gigabyte, GB, of storage, and
default carbon emissions per floating point operations per second, FLOPS, of computing.

18. The communication apparatus of claim 15,
wherein the actual execution capabilities comprise:
an identifier of the execution node (82),
a status of the execution node (82),
an actual computing capacity of the execution node (82),
an actual energy capacity of the execution node (82),
a percentage of the actual energy capacity relating to renewable energy supply and exceeding a general energy demand at the execution node (82);
an actual energy capacity prediction of the execution node (82),
actual carbon emissions per gigabyte, GB, of communication,
actual carbon emissions per gigabyte, GB, of storage,
actual carbon emissions per floating point operations per second, FLOPS, of computing,
an identifier of an event underlying the capability advertisement message, and
a validity period of the actual execution capabilities.

19. The communication apparatus of claim 15,
wherein the event comprises a periodic event.

20. The communication apparatus of claim 15,
wherein the scheduling policy comprise one of:
a closest match of the execution requirements and their applicable execution capabilities,
a closest geographic proximity relative to users of the functional component (6),
a lowest latency relative to the users of the functional component (6),
a best performance associated with the execution of the functional component (6),
a least energy cost associated with an execution of the functional component (6), and
a least carbon emission associated with the execution of the functional component (6).
